(19) United States
(12) Patent Application Publication
(10) Pub. No.: US 2026/0093444 A1
(43) Pub. Date: Apr. 2, 2026

(54) AUDIO LINK CONNECTION BASED ON STATE INFORMATION

(71) Applicant: Motorola Mobility LLC, Chicago, IL (US)

(72) Inventors: Amit Kumar Agrawal, Bangalore (IN); Michael E. Russell, Lake Zurich, IL (US); Rohit Sisodia, Naperville, IL (US)

(73) Assignee: Motorola Mobility LLC, Chicago, IL (US)

(21) Appl. No.: 19/199,984

(22) Filed: May 6, 2025

(30) Foreign Application Priority Data
Oct. 1, 2024 (IN) 202411074349

(51) Int. Cl. G06F 3/16

(52) U.S. Cl. CPC G06F 3/165; G06F 3/162

(57) ABSTRACT

Techniques for audio link connection based on state information are described and are implementable to determine that an audio link to a wireless audio device is available to the mobile device and to a user device different than the mobile device. State information associated with one or more of the mobile device or the user device can be compared to a priority table to determine a routing priority for the audio link, and the audio link to the wireless audio device can be connected to the mobile device or the user device based at least in part on the routing priority.

### RELATED APPLICATION

This application claims priority to India patent application No. 202411074349, filed 1 Oct. 2024, entitled “AUDIO LINK CONNECTION BASED ON STATE INFORMATION,” the disclosure of which is incorporated by reference herein in its entirety.

### BACKGROUND

The wide availability of wireless devices offers users a tremendous number of wireless connectivity options. For instance, wireless devices (e.g., mobile phones, laptops, wearable devices, etc.) can connect to wireless networks to perform different tasks. Further, wireless devices can directly interconnect such as to enable direct data intercommunication between wireless devices. In one particularly useful implementation, users can connect wireless audio devices (e.g., headphones, earbuds, etc.) to their wireless devices to enable audio to be streamed from the wireless devices to their wireless audio devices. In many scenarios, however, users have multiple different wireless devices and thus managing connectivity of a wireless audio device among multiple wireless connectivity sources can be challenging.

### BRIEF DESCRIPTION OF THE DRAWINGS

Aspects of audio link connection based on state information are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of audio link connection based on state information can be implemented.

FIG. 2 illustrates an example scenario for audio link connection based on state information in accordance with one or more implementations.

FIG. 3 illustrates an example scenario for audio link connection based on state information in accordance with one or more implementations.

FIG. 4 illustrates a flow chart depicting an example method for audio link connection based on state information in accordance with one or more implementations.

FIG. 5 illustrates a flow chart depicting an example method for audio link connection based on state information in accordance with one or more implementations.

FIG. 6 illustrates a flow chart depicting an example method for audio link connection based on state information in accordance with one or more implementations.

FIG. 7 illustrates various components of an example device in which aspects of audio link connection based on state information can be implemented.

### DETAILED DESCRIPTION

Techniques for audio link connection based on state information are described and are implementable to enable connectivity of different devices (e.g., mobile devices, computing devices) to wireless audio devices (e.g., earbuds, headphones) to be managed based on different types of state information.

For example, consider a scenario in which a mobile phone is connected to wireless headphones and a user is utilizing the mobile phone to perform a voice call via a communication application (e.g., a videoconference application) on the mobile phone. The wireless headphones, for instance, can be used for voice output and voice input for the voice call. The user then enters their office, sits down at their laptop, and transfers the voice call to an instance of the communication application on the laptop. In legacy scenarios, the user would need to perform a manual reconnection of the wireless headphones from the mobile phone to the laptop in order to utilize the wireless headphones as part of the voice call on the laptop.

Accordingly, techniques described herein enable automated connectivity management and switching for wireless audio devices based on state information shared between different connected devices. For instance, in the scenario described above, an arbitrator module on the mobile phone and/or the laptop can determine that based on the user transferring the voice call to the laptop, that the laptop is to have priority for connectivity to the wireless headphones. Accordingly, the arbitrator module can implement an automated connectivity switch to cause an audio link to the wireless headphones to be switched from the mobile phone to the laptop to enable the user to seamlessly continue the voice call on the laptop without having to perform a manual connectivity process on the laptop. Other details and implementations of the described systems and techniques are described below and in the accompanying figures.

Accordingly, techniques for audio link connection based on state information can be implemented to manage audio links between different devices and thus avoid scenarios where audio content may be missed and/or lost.

While features and concepts of audio link connection based on state information can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

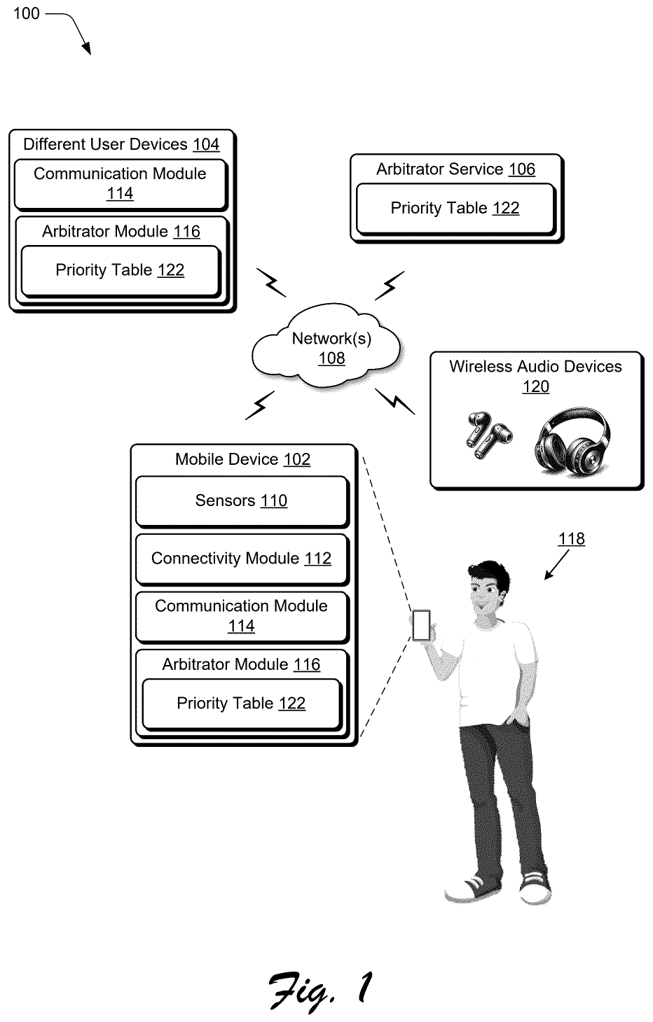

FIG. 1 illustrates an example environment 100 in which aspects of audio link connection based on state information can be implemented. The environment 100 includes a mobile device 102, different user devices 104, an arbitrator service 106, and one or more network(s) 108. The mobile device 102 can be implemented in different ways, such as a mobile phone, a tablet device, a wearable device, an extended reality (e.g., virtual reality, mixed reality) device, etc. The different user devices 104 can also be implemented in different ways, such as a mobile device (examples of which are mentioned throughout this disclosure), a laptop computing device, a desktop computing device, a smart device system, etc. The arbitrator service 106 represents a network-based service that can communicate with the mobile device 102 and the different user devices 104 (e.g., via the network(s) 108) to perform and/or assist with various operations pertaining to audio link connection based on state information described herein.

The network(s) 108 can represent instances and/or combinations of wireless and wired networks via which the mobile device 102, the different user devices 104, and the arbitrator service 106 can participate in various types of communication, such as wired and/or wireless data communication. The network(s) 108 can be implemented according to different architectures such as a wide area network (WAN), a wireless local area network (WLAN), peer-to-peer (P2P) networks, etc. For instance, (e.g., in P2P network scenarios), the mobile device 102 and the different user devices 104 can perform direct inter-device connectivity and data communication using any suitable connectivity protocol, such as Bluetooth, Bluetooth Low Energy (BLE), Generic Attribute Profile (GATT) communication, WiFi Direct, and/or any other suitable short-range wireless technology.

The mobile device 102 includes functionality that is operable in association with techniques for audio link connection based on state information described herein including sensors 110, a connectivity module 112, a communication module 114, and an arbitrator module 116. The sensors 110 are representative of functionality to detect various physical and/or logical phenomena in relation to the mobile device 102, such as device location, position, motion, light, image detection and recognition, time and date, touch detection, sound (e.g., voice), temperature, and so forth. Examples of the sensors 110 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. The sensors 110, however, can include a variety of other sensor types in accordance with the implementations discussed herein.

The connectivity module 112 represents functionality for enabling various types of wireless and wired connectivity and communication of the mobile device 102. The connectivity module 112, for instance, enables wireless connectivity and communication of the mobile device 102, such as connectivity and communication via the network(s) 108. The communication module 114 represents functionality for enabling various types of communication, such as voice communication, video communication, text communication, content communication, and combinations thereof. In at least some implementations the communication module 114 represents a multimedia communication application via which a user 118 of the mobile device 102 and/or the different user devices 104 can exchange different media types with other users, such as in real time.

The arbitrator module 116 represents functionality for performing various aspects of audio link connection based on state information described herein. For instance, the arbitrator module 116 can manage connectivity and data routing for wireless audio devices 120. The wireless audio devices 120, for example, enable output of audio content (e.g., audio data streams) from the mobile device 102 and the different user devices 104. Examples of the wireless audio devices 120 include wireless earbuds, wireless headphones, wireless external speakers, and so forth. The user 118, for example, can utilize (e.g., wear) the wireless audio devices 120 to output audio content generated and/or obtained via the mobile device 102 and the different user devices 104.

The arbitrator module 116 includes and/or has access to a priority table 122 for managing audio connectivity routing to the wireless audio devices 120. The priority table 122, for instance, includes rules and parameters for determining which devices are to be connected to audio channels of the wireless audio devices 120.

For example, the priority table 122 maps different devices and device states to priority values which can be used by the arbitrator module 116 to perform audio routing to the wireless audio devices 120. For instance, a device and/or device state with a higher priority value in the priority table 122 can be prioritized for audio routing to the wireless audio devices 120. In at least one implementation the priority table 122 can be implemented as a lookup table.

The arbitrator service 106 is representative of a network-based service that can assist in performing and/or assisting with various aspects of audio link connection based on state information described herein. For instance, the arbitrator service 106 includes an instance of the priority table 122 that can be utilized to manage audio connectivity routing between the mobile device 102, the different user devices 104, and the wireless audio devices 120.

The different user devices 104 include instances of the arbitrator module 116 and the priority table 122 which are implementable to perform various aspects of audio link connection based on state information described herein. The mobile device 102, the different user devices 104, and the arbitrator service 106 can be implemented in various ways and include various functionality, examples of which are discussed below with reference to the example device 700 of FIG. 7.

Having discussed an example environment in which the disclosed techniques can be performed, consider now some example scenarios and implementation details for implementing the disclosed techniques.

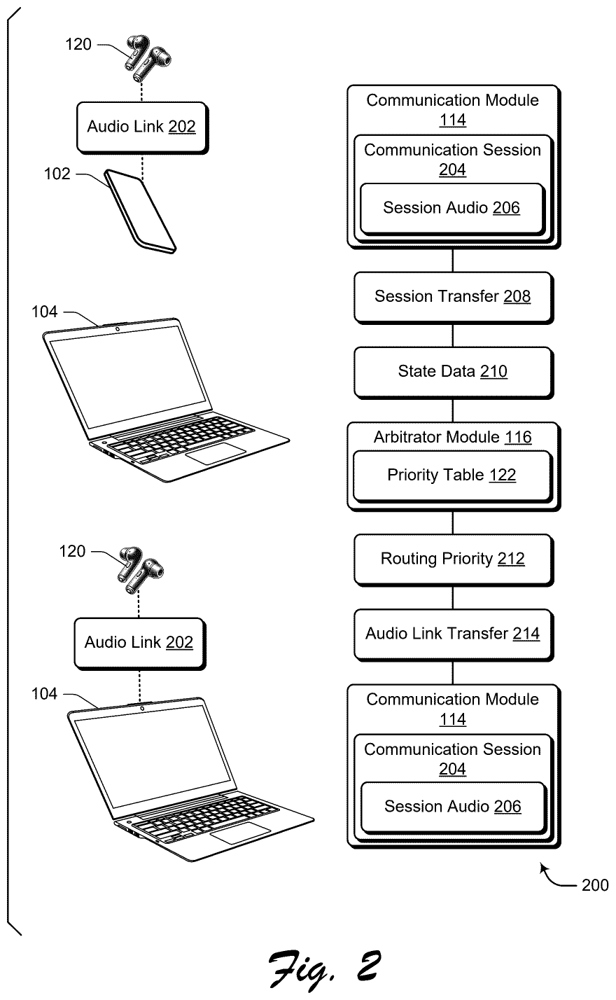

FIG. 2 illustrates an example scenario 200 for audio link connection based on state information in accordance with one or more implementations. The scenario 200, for example, can be implemented in the context of the environment 100. In the scenario 200 the mobile device 102 is connected to a wireless audio device 120 via an audio link 202 such that audio generated at the mobile device 102 can be output via the wireless audio device 120. In this particular example, a communication session 204 is active via the communication module 114 on the mobile device 102. The communication session 204, for instance, can represent a real-time exchange of communication media between different user devices, such as audio, video, etc. The communication session 204 includes session audio 206 that is transmitted from the mobile device 102 over the audio link 202 and output by the wireless audio device 120.

Further to the scenario 200, a session transfer 208 is initiated to transfer the communication session 204 from the mobile device 102 to a different user device 104. For instance, while the communication session 204 is active on the mobile device 102, the user 118 performs an action to transfer control of the communication session 204 from the mobile device 102 to the different user device 104. Accordingly, the arbitrator module 116 receives state data 210 indicating the session transfer 208 and utilizes the state data 210 to search the priority table 122 and determine a routing priority 212 for the audio link 202. In this particular example, the routing priority 212 indicates that the different user device 104 has higher routing priority than the mobile device 102, and thus an audio link transfer 214 is initiated to transfer the audio link 202 from the mobile device 102 to the different user device 104. For instance, as part of the audio link transfer 214, the mobile device 102 disconnects the audio link 202 and the different user device 104 connects the audio link 202 to the wireless audio device 120.

Accordingly, the session audio 206 for the communication session 204 can be transmitted from the different user device 104 to the wireless audio device 120 via the transferred audio link 202. According to implementations, the audio link transfer 214 is performed automatically in response to the session transfer 208 and independent of user input to specify that the audio link 202 is to be transferred from the mobile device 102 to the different user device 104.

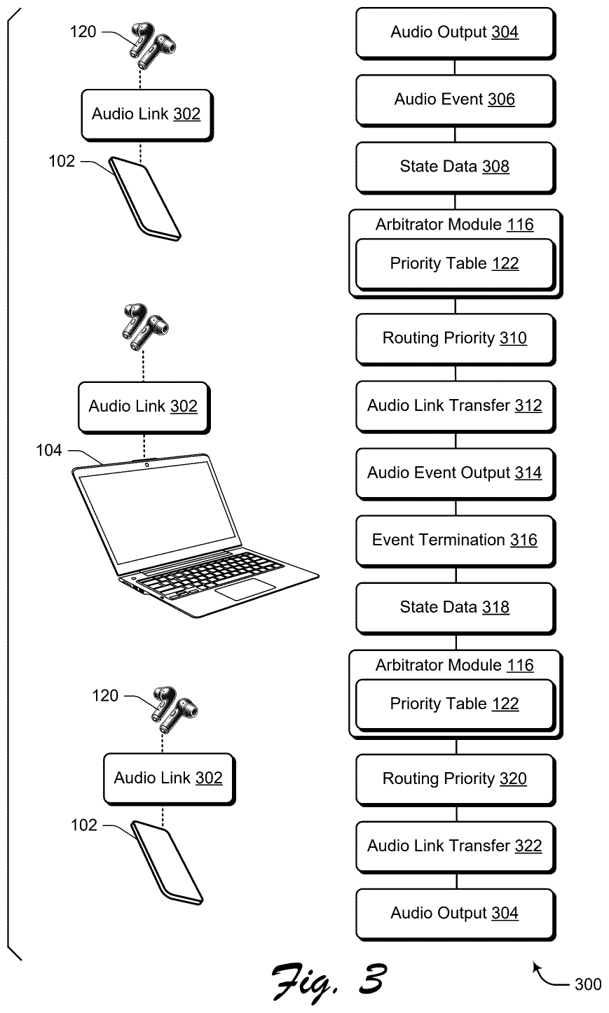

FIG. 3 illustrates an example scenario 300 for audio link connection based on state information in accordance with one or more implementations. The scenario 300, for example, can be implemented in the context of the environment 100. In the scenario 300 the mobile device 102 is connected to a wireless audio device 120 via an audio link 302 such that audio output 304 generated at the mobile device 102 can be output via a wireless audio device 120. The audio output 304 can represent various types of audio generated via the mobile device 102, such as streaming music, an audio book, audio content associated with video content, a podcast, etc.

While the audio output 304 is being output by the wireless audio device 120, an audio event 306 occurs at the different user device 104. The audio event 306 can occur in response to various events at the different user device 104, such as receiving a notification at the different user device 104. Examples of such notifications include a new email notification, a text message, an app notification, a calendar reminder, etc. Based at least in part on the audio event 306 the arbitrator module 116 receives state data 308 identifying the audio event 306 at the different user device 104 and the arbitrator module 116 utilizes the state data 308 to search the priority table 122 and determine a routing priority 310 for the audio link 202. In this particular example, the routing priority 310 indicates that the different user device 104 has higher routing priority than the mobile device 102, and thus an audio link transfer 312 is initiated to transfer the audio link 302 from the mobile device 102 to the different user device 104. For instance, as part of the audio link transfer 312, the mobile device 102 disconnects the audio link 302 and the different user device 104 connects the audio link 302 to the wireless audio device 120. The different user device 104 implements audio event output 314 of the audio event 306 via the wireless audio device 120 using the audio link 302.

Further to the scenario 300 an event termination 316 occurs indicating that the audio event 306 is terminated, e.g., that the audio event output 314 is complete.

Accordingly, based at least in part on the event termination 316 the arbitrator module 116 receives state data 318 identifying the event termination 316 and the arbitrator module 116 utilizes the state data 318 to search the priority table 122 and determine a routing priority 320 for the audio link 202. In this particular example, the routing priority 320 indicates that the mobile device 102 has higher routing priority than the different user device 104, and thus an audio link transfer 322 is initiated to transfer the audio link 302 from the different user device 104 to the mobile device 102. For instance, as part of the audio link transfer 322, the different user device 104 disconnects the audio link 302 and the mobile device 102 connects the audio link 302 to the wireless audio device 120. In at least one implementation, in response to the audio link transfer 322 the mobile device 102 can automatically resume the audio output 304 to the wireless audio device 120.

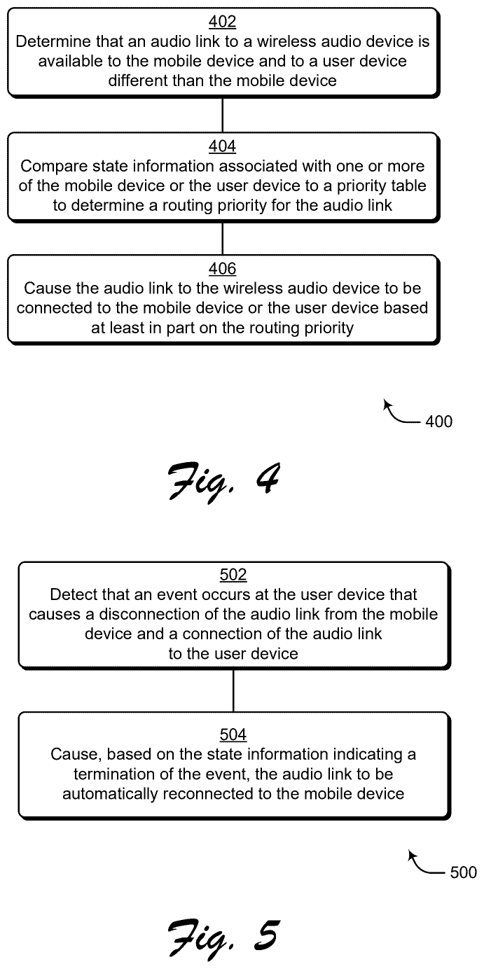

FIG. 4 illustrates a flow chart depicting an example method 400 for audio link connection based on state information in accordance with one or more implementations. Operations of the method 400, for instance, may be performed in the context of the environment 100, such as by the mobile device 102, the different user devices 104, and/or the arbitrator service 106.

At 402 it is determined that an audio link to a wireless audio device is available to the mobile device and to a user device different than the mobile device.

The arbitrator module 116, for instance, determines that an audio link to a wireless audio device 120 is available to both the mobile device 102 and a different user device 104. At 404 state information associated with one or more of the mobile device or the user device is compared to a priority table to determine a routing priority for the audio link. The arbitrator module 116, for example, compares the state information to the priority table 122 to determine which device has priority for the audio link. At 406 the audio link to the wireless audio device is caused to be connected to the mobile device or the user device based at least in part on the routing priority. For example, the audio link is connected to the mobile device 102 or the different user device 104 based on which device is indicated to have a higher routing priority.

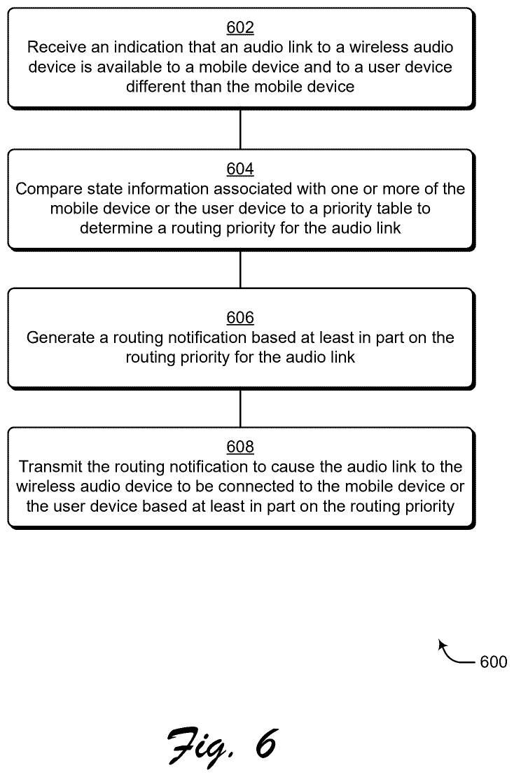

FIG. 5 illustrates a flow chart depicting an example method 500 for audio link connection based on state information in accordance with one or more implementations. Operations of the method 500, for instance, may be performed in the context of the environment 100, such as by the mobile device 102, the different user devices 104, and/or the arbitrator service 106. Further, the method 500 may be implemented in conjunction with the method 400.

At 502 it is detected that an event occurs at the user device that causes a disconnection of the audio link from the mobile device and a connection of the audio link to the user device. In at least one implementation the event can correspond to an audio notification that occurs at a different user device 104 while an audio link is established between the mobile device 102 and a wireless audio device 120. At 504, based on the state information indicating a termination of the event, the audio link is caused to be automatically reconnected to the mobile device. For instance, where an audio event at the different user device 104 is terminated (e.g., complete), the audio link to the wireless audio device 120 is retransferred from the different user device 104 to the mobile device 102.

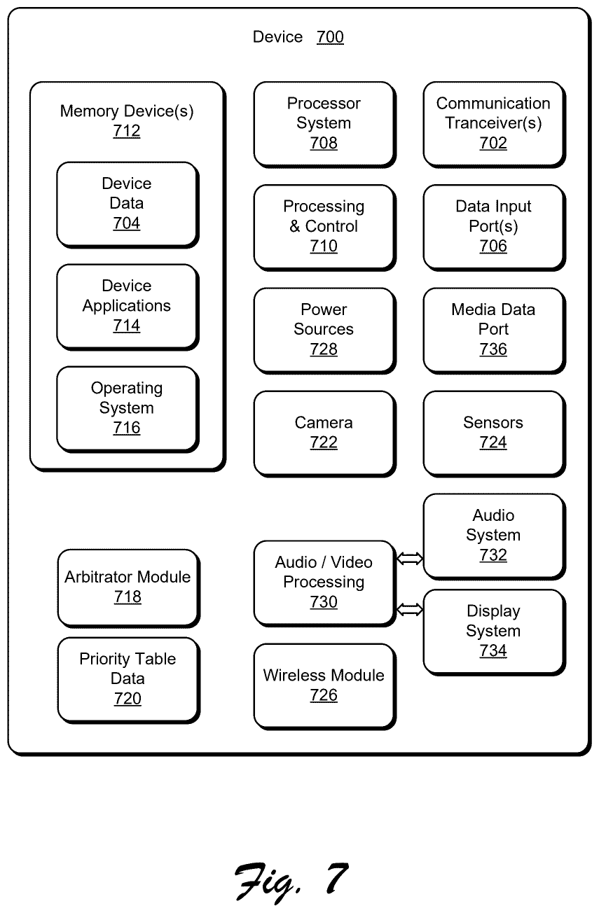

FIG. 6 illustrates a flow chart depicting an example method 600 for audio link connection based on state information in accordance with one or more implementations. Operations of the method 600, for instance, may be performed in the context of the environment 100, such as by the mobile device 102, the different user devices 104, and/or the arbitrator service 106. Further, the method 600 may be implemented in conjunction with the methods 400, 500.

At 602 an indication is received that an audio link to a wireless audio device is available to a mobile device and to a user device different than the mobile device. The arbitrator service 106, for example, detects that an audio link to a wireless audio device 120 is available to both the mobile device 102 and a different user device 104. At 604 state information associated with one or more of the mobile device or the user device is compared to a priority table to determine a routing priority for the audio link. At 606 a routing notification is generated based at least in part on the routing priority for the audio link. The arbitrator service 106, for instance, generates a routing notification that identifies which device (e.g., the mobile device 102 or the different user device 104) has current routing priority for audio link connectivity to the wireless audio device 120.

At 608 the routing notification is transmitted to cause the audio link to the wireless audio device to be connected to the mobile device or the user device based at least in part on the routing priority. For example, the arbitrator service 106 transmits the routing notification to the mobile device 102 and/or the different user device 104 to cause an audio link with the wireless audio device 120 to be established by a device with a highest routing priority.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 7 illustrates various components of an example device 700 in which aspects of audio link connection based on state information can be implemented. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of electronic device. For example, the mobile device 102, the different user devices 104, and/or the arbitrator service 106 as shown and described with reference to FIGS. 1-6 may be implemented as the example device 700.

The device 700 includes communication transceivers 702 that enable wired and/or wireless communication of device data 704 with other devices. The device data 704 can include one or more of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processing system 708 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes an arbitrator module 718 and priority table data 720 that can implement aspects of audio link connection based on state information and may be implemented with hardware components and/or in software. For example, the arbitrator module 718 can be implemented as the arbitrator module 116, described in detail above. In implementations, the arbitrator module 718 may include independent processing, memory, and logic components as a computing and/or electronic device integrated with the device 700. Further, the priority table data 720 can include data usable as part of the described techniques, such as to generate different priority tables 122.

In this example, the example device 700 also includes a camera 722 and sensors 724. The sensors 724 can be implemented in various ways and are representative of functionality to detect various physical and/or logical phenomena in relation to the device 700, such as motion, light, image detection and recognition, time and date, position, location, touch detection, sound, temperature, and so forth. Examples of the sensors 724 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth.

The device 700 also includes a wireless module 726, which is representative of functionality to perform various wireless communication tasks. The device 700 can also include one or more power sources 728, such as when the device is implemented as a mobile device. The power sources 728 may include a charging and/or power system, and can be implemented as a flexible strip battery, a rechargeable battery, a charged super-capacitor, and/or any other type of active or passive power source.

The device 700 also includes an audio and/or video processing system 730 that generates audio data for an audio system 732 and/or generates display data for a display system 734. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 736. In implementations, the audio system and/or the display system are integrated components of the example device. Alternatively, the audio system and/or the display system are external, peripheral components to the example device.

Although implementations of audio link connection based on state information have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a mobile device including: at least one memory; and at least one processor coupled with the at least one memory and configured to cause the mobile device to: determine that an audio link to a wireless audio device is available to the mobile device and to a user device different than the mobile device; compare state information associated with one or more of the mobile device or the user device to a priority table to determine a routing priority for the audio link; and cause the audio link to the wireless audio device to be connected to the mobile device or the user device based at least in part on the routing priority.

In some aspects, the techniques described herein relate to a mobile device, wherein the at least one processor is configured to cause the mobile device to communicatively connect the mobile device to the user device to enable an exchange of the state information between the mobile device and the user device.

In some aspects, the techniques described herein relate to a mobile device, wherein the at least one processor is configured to cause the mobile device and the user device to exchange the state information via one or more of Bluetooth Low Energy (BLE) advertisement or Generic Attribute Profile (GATT) communication.

In some aspects, the techniques described herein relate to a mobile device, wherein the at least one processor is configured to cause the mobile device to determine that the wireless audio device is connected to the mobile device and the user device via dual wireless connectivity.

In some aspects, the techniques described herein relate to a mobile device, wherein the state information indicates that a communication session is transferred from the mobile device to the user device, and the routing priority indicates that the audio link is to be transferred from the mobile device to the user device.

In some aspects, the techniques described herein relate to a mobile device, wherein the at least one processor is configured to cause the mobile device to cause the audio link to be disconnected from the mobile device and connected to the user device.

In some aspects, the techniques described herein relate to a mobile device, wherein the at least one processor is configured to cause the mobile device to cause the audio link to the wireless audio device to be transferred between the mobile device and the user device based at least in part on the routing priority.

In some aspects, the techniques described herein relate to a mobile device, wherein the at least one processor is configured to cause the mobile device to cause the audio link to the wireless audio device to be transferred between the mobile device and the user device automatically and independent of user input to transfer the audio link.

In some aspects, the techniques described herein relate to a mobile device, wherein the at least one processor is configured to cause the mobile device to: detect that an event occurs at the user device that causes a disconnection of the audio link from the mobile device and a connection of the audio link to the user device; and cause, based on the state information indicating a termination of the event, the audio link to be automatically reconnected to the mobile device.

In some aspects, the techniques described herein relate to a mobile device, wherein the event includes an audio notification event at the user device.

In some aspects, the techniques described herein relate to a mobile device, wherein the at least one processor is configured to cause the mobile device to: cause an audio stream from the mobile device to be output by the wireless audio device via connectivity of the audio link between the mobile device and the wireless audio device; detect that an event occurs at the user device that causes a disconnection of the audio link from the mobile device and a connection of the audio link to the user device; and cause, based on the state information indicating a termination of the event, the audio link to be automatically reconnected to the mobile device and the audio stream to resume.

In some aspects, the techniques described herein relate to a method including: determining that an audio link to a wireless audio device is available to a mobile device and to a user device different than the mobile device; comparing state information associated with one or more of the mobile device or the user device to a priority table to determine a routing priority for the audio link; and causing the audio link to the wireless audio device to be connected to the mobile device or the user device based at least in part on the routing priority.

In some aspects, the techniques described herein relate to a method, further including communicatively connecting the mobile device to the user device to enable an exchange of the state information between the mobile device and the user device.

In some aspects, the techniques described herein relate to a method, wherein the state information indicates that a communication session is transferred from the mobile device to the user device, and the routing priority indicates that the audio link is to be transferred from the mobile device to the user device.

In some aspects, the techniques described herein relate to a method, further including causing the audio link to be disconnected from the mobile device and connected to the user device.

In some aspects, the techniques described herein relate to a method, further including causing the audio link to the wireless audio device to be transferred between the mobile device and the user device based at least in part on the routing priority.

In some aspects, the techniques described herein relate to a method, further including: detecting that an event occurs at the user device that causes a disconnection of the audio link from the mobile device and a connection of the audio link to the user device; and causing, based on the state information indicating a termination of the event, the audio link to be automatically reconnected to the mobile device.

In some aspects, the techniques described herein relate to a system including: at least one memory; and at least one processor coupled to the at least one memory and configured to cause the system to: receive an indication that an audio link to a wireless audio device is available to a mobile device and to a user device different than the mobile device; compare state information associated with one or more of the mobile device or the user device to a priority table to determine a routing priority for the audio link; generate a routing notification based at least in part on the routing priority for the audio link; and transmit the routing notification to cause the audio link to the wireless audio device to be connected to the mobile device or the user device based at least in part on the routing priority.

In some aspects, the techniques described herein relate to a system, wherein the state information indicates that a communication session is transferred from the mobile device to the user device, and the routing priority indicates that the audio link is to be transferred from the mobile device to the user device.

In some aspects, the techniques described herein relate to a system, wherein the routing notification includes an instruction to disconnect the audio link from the mobile device and connect the audio link to the user device.

1. A mobile device comprising:
at least one memory; and
at least one processor coupled with the at least one memory and configured to cause the mobile device to:
determine that an audio link to a wireless audio device is available to the mobile device and to a user device different than the mobile device;
compare state information associated with one or more of the mobile device or the user device to a priority table to determine a routing priority for the audio link; and
cause the audio link to the wireless audio device to be connected to the mobile device or the user device based at least in part on the routing priority.

2. The mobile device of claim 1, wherein the at least one processor is configured to cause the mobile device to communicatively connect the mobile device to the user device to enable an exchange of the state information between the mobile device and the user device.

3. The mobile device of claim 2, wherein the at least one processor is configured to cause the mobile device and the user device to exchange the state information via one or more of Bluetooth Low Energy (BLE) advertisement or Generic Attribute Profile (GATT) communication.

4. The mobile device of claim 1, wherein the at least one processor is configured to cause the mobile device to determine that the wireless audio device is connected to the mobile device and the user device via dual wireless connectivity.

5. The mobile device of claim 1, wherein the state information indicates that a communication session is transferred from the mobile device to the user device, and the routing priority indicates that the audio link is to be transferred from the mobile device to the user device.

6. The mobile device of claim 5, wherein the at least one processor is configured to cause the mobile device to cause the audio link to be disconnected from the mobile device and connected to the user device.

7. The mobile device of claim 1, wherein the at least one processor is configured to cause the mobile device to cause the audio link to the wireless audio device to be transferred between the mobile device and the user device based at least in part on the routing priority.

8. The mobile device of claim 1, wherein the at least one processor is configured to cause the mobile device to cause the audio link to the wireless audio device to be transferred between the mobile device and the user device automatically and independent of user input to transfer the audio link.

9. The mobile device of claim 1, wherein the at least one processor is configured to cause the mobile device to:
detect that an event occurs at the user device that causes a disconnection of the audio link from the mobile device and a connection of the audio link to the user device; and
cause, based on the state information indicating a termination of the event, the audio link to be automatically reconnected to the mobile device.

10. The mobile device of claim 9, wherein the event comprises an audio notification event at the user device.

11. The mobile device of claim 1, wherein the at least one processor is configured to cause the mobile device to:
cause an audio stream from the mobile device to be output by the wireless audio device via connectivity of the audio link between the mobile device and the wireless audio device;
detect that an event occurs at the user device that causes a disconnection of the audio link from the mobile device and a connection of the audio link to the user device; and
cause, based on the state information indicating a termination of the event, the audio link to be automatically reconnected to the mobile device and the audio stream to resume.

12. A method comprising:
determining that an audio link to a wireless audio device is available to a mobile device and to a user device different than the mobile device;
comparing state information associated with one or more of the mobile device or the user device to a priority table to determine a routing priority for the audio link; and
causing the audio link to the wireless audio device to be connected to the mobile device or the user device based at least in part on the routing priority.

13. The method of claim 12, further comprising communicatively connecting the mobile device to the user device to enable an exchange of the state information between the mobile device and the user device.

14. The method of claim 12, wherein the state information indicates that a communication session is transferred from the mobile device to the user device, and the routing priority indicates that the audio link is to be transferred from the mobile device to the user device.

15. The method of claim 14, further comprising causing the audio link to be disconnected from the mobile device and connected to the user device.

16. The method of claim 12, further comprising causing the audio link to the wireless audio device to be transferred between the mobile device and the user device based at least in part on the routing priority.

17. The method of claim 12, further comprising:
detecting that an event occurs at the user device that causes a disconnection of the audio link from the mobile device and a connection of the audio link to the user device; and
causing, based on the state information indicating a termination of the event, the audio link to be automatically reconnected to the mobile device.

18. A system comprising:
at least one memory; and
at least one processor coupled to the at least one memory and configured to cause the system to:
receive an indication that an audio link to a wireless audio device is available to a mobile device and to a user device different than the mobile device;
compare state information associated with one or more of the mobile device or the user device to a priority table to determine a routing priority for the audio link;
generate a routing notification based at least in part on the routing priority for the audio link; and
transmit the routing notification to cause the audio link to the wireless audio device to be connected to the mobile device or the user device based at least in part on the routing priority.

19. The system of claim 18, wherein the state information indicates that a communication session is transferred from the mobile device to the user device, and the routing priority indicates that the audio link is to be transferred from the mobile device to the user device.

20. The system of claim 19, wherein the routing notification comprises an instruction to disconnect the audio link from the mobile device and connect the audio link to the user device.
